(19) United States
(12) Patent Application Publication
(10) Pub. No.: US 2009/0112728 A1
(43) Pub. Date: Apr. 30, 2009

(54) System and method for small business management

(75) Inventors: Ridgely C. Evers, Healdsburg, CA (US); Robert C. Benedict, Napa, CA (US)

Correspondence Address: Stevens Law Group, 1754 Technology Drive, Suite #226, San Jose, CA, 95110, US

(73) Assignee: Netbooks, Inc., Rohnert Park, CA (US)

(21) Appl. No.: 12/034,620

(22) Filed: Feb. 20, 2008

Related U.S. Application Data
(60) Provisional application No. 60/902,574, filed on Feb. 20, 2007.

(51) Int. Cl. G06Q 10/00; G06Q 30/00

(52) U.S. Cl. 705/26; 705/34; 705/28

(57) ABSTRACT

Provided is a system and method for straight-through processing and integration of disparate business process information. The system includes an order intake configured to receive an order from a customer, a fulfillment processor configured to automatically fulfill an order received, an inventory tracker configured to automatically account for the fulfilled order upon fulfillment, and an accounting processor configured to automatically invoice a customer for the fulfilled order.

### BACKGROUND

The prior art figure shows a conventional business management system. The conventional business management system includes multiple functional units that are used to track operations for each of the separate business units such as sales, shipping, and bookkeeping. In order to track progress within each of these functional business units, a specialized application that is tailored to the particular business units needs is typically implemented. For example, a sales application is used by the sales business unit to track sales contacts; a shipping application is used by the shipping business unit to track inventory; and a bookkeeping application is used by the bookkeeping unit to track accounts receivable.

Information for each of the separate functional business units is stored in separate data repositories. In particular, the data used with the sales application is stored in a sales data repository; the data used with the shipping application is stored in a shipping repository; and the data used with the bookkeeping unit is stored in a bookkeeping repository. When business operations shift among the different functional business units, the data from each functional business unit is transferred among the data repositories coupled to the various functional business units. For example, when a sale is made, data from the sales application is transferred from the sales repository to the shipping repository so the shipping application can facilitate appropriate shipping operations.

Additionally, the conventional business management system is typically set up so that different users access the different functional applications. For example, the sales team is authorized to access the sales data stored in the sales repository; the shipping team is authorized to access the shipping data stored in the shipping repository; and the bookkeeping team is authorized to store the bookkeeping data stored in the bookkeeping repository. In this way, the data corresponding to the various business units is separated and separately accessible. In this way, a person from a particular business unit accesses and manipulates their own instance, or copy, of the data, but they cannot access the data stored for another business unit, even though the data may have originated from the other business unit.

These characteristics of the conventional business management system derive from the way in which the different business unit applications have been developed. In many instances, customized software applications and user interfaces have been developed for very large corporations, but these enterprise-level solutions are typically not suitable for smaller companies, especially small entrepreneurial businesses. In particular, the conventional business management systems are not suited for small businesses because of their cost and complexity.

### BRIEF DESCRIPTION OF THE DRAWINGS

FIG. 1 is diagrammatic view of a system configured according to the invention.

FIG. 2 is a FIG. 1 is diagrammatic view of a system configured according to the invention.

FIG. 3 is diagrammatic view of a system configured according to the invention.

FIG. 4 is diagrammatic view of a system configured according to the invention.

FIGS. 5-57 are screen productions of application user interfaces according to the invention.

### DETAILED DESCRIPTION

The description below includes examples and embodiments of the invention, which is defined by the appended claims and their equivalents. The description also includes the appendixes included herewith, that shows in detail an embodiment of the invention.

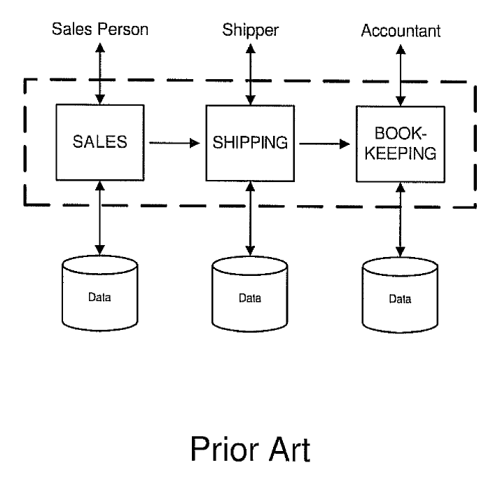

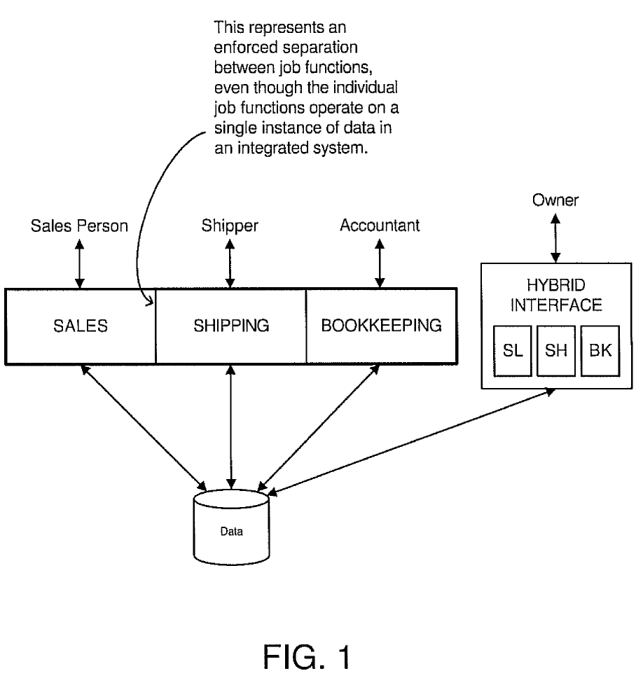

FIG. 1 illustrates one embodiment of a business management system that is suitable for use by small businesses. The depicted business management system includes a software application that allows separate interfaces for traditional business units, as well as a hybrid interface for management or operation by even a single person. For example, the software application has a sales interface, a shipping interface, and a bookkeeping interface. The sales interface is configured to allow a sales person to access and manipulate data related to sales operations. Similarly, the shipping and bookkeeping interfaces allow shipping and bookkeeping personnel to access and manipulate data related to shipping and bookkeeping operations. Although the illustrated business management system only shows three separate interfaces, other embodiments may implement additional separate interfaces for other functional business units. The separate interfaces allow each user or function business unit to access a single instance of data at a single repository. It should be noted that a single repository may be a one or more data storage devices.

In contrast to the individual interfaces, the hybrid interface facilitates control and management of the business data by even a single person. For example, the hybrid interface allows a business owner to access and manipulate data related to any or all of the separate functional business units such as sales, shipping, and bookkeeping. It should be noted that the hybrid interface, similar to the other individual interfaces work with the same data that is stored in the data repository. In this way, the data in the data repository can be used by all of the functional business units in a straight-through processing system. Data does not need to be transferred among the different functional business units and their corresponding data repositories. In order to facilitate these different types of individual and hybrid interfaces with a single repository of data, user permissions can be implemented, as described in more detail in the accompanying documentation.

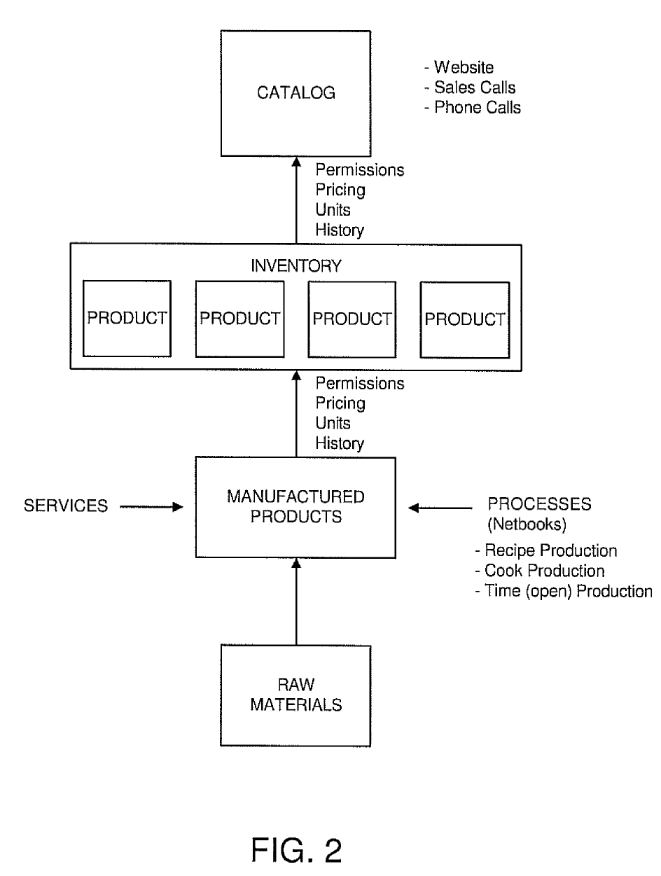

FIG. 2 illustrates a process flow diagram of one embodiment of the functionality of the business management system of FIG. 1. Although a particular process flow is illustrated in FIG. 2, the business management system of FIG. 1 may be capable of implementing variations of the depicted process flow. Additionally, the business management system may implement other process flows that are not depicted in FIG. 2.

The illustrated process flow diagram shows one embodiment of how services (e.g., labor) and processes are used to turn raw materials into manufactured products. It should be noted that there are different types of processes, facilitated by the business management system, which can be implemented depending on the type of product being manufactured or the nature of the approach used to produce the manufactured products. Three of these processes are designated as recipe production, cook production, and time (or open) production. A short description of each process is provided here, and additional details of each type of process are provided in the accompanying documentation.

Recipe production refers to generating the manufactured products from the raw materials by using a predetermined set of steps or operations. Similar to a recipe used for baking, the recipe production uses an outlined set of operations, which specify quantities, order or execution, and so forth. In this way, the manufactured products are produced without deviation (or with insignificant deviation) from the predetermined process.

Cook production, in contrast to recipe production, does not require rigid conformance to a predetermined set of steps or operations. Rather, cook production allows personnel to deviate from a recipe or not use predetermined operations at all, so that the resulting product is not necessarily known beforehand. For example, using cook production, personnel might create a batch of food product using a variety of ingredients or a variety of measurements, without knowing in advance what those ingredients and/or measurements might be. Additionally, one embodiment of the business management system facilitates recordation of the operations, ingredients, measurements, and other pertinent information so that a subsequent batch might be produced using the recipe production process.

Time, or open, production also allows personnel to introduce some variance into the manufacturing process. However, in contrast to cook production, time production accommodates the aging process of some products such as wine. Since it is not necessarily known beforehand how long wine might be allowed to age before it is sold and shipped, the time production process allows personnel to track the aging process for later use.

After the manufactured products are generated, the business management system correlates the manufactured products with inventory. In one embodiment, the business management system uses a set of permissions, pricing, unit conversion, and historic data to populate an inventory database. The permissions, pricing, units, and history are described in more detail in the accompanying documentation. As an introduction, though, it should be noted that the permissions can be set for each user to indicate which interface(s) are accessible by each user. The pricing operations include rounding based on predefined parameters. The unit operations includes converting between various measurement units, including metric and imperial measurement units, as well as converting between quantities and groupings (e.g., one case may equal twelve bottles for a given product).

The business management system also correlates inventory to a catalog, which conveys the available products to a potential buyer, or customer. Embodiments of the catalog can be implemented in many different forms. For example, the catalog may be implemented as a website. The information in the catalog can also be used during sales calls and phone calls to existing and new customers. Like the correlation between the manufactured products and the inventory, the correlation between the inventory and the products can also account for permissions, pricing, units, and historical data. In one embodiment, the permissions also can indicate which customers are permitted to purchase certain products at specified prices. For example, some customers may be permitted to buy products at a 100% markup, while other customers may be permitted to buy the same type of product at a 150% markup, depending on the type of customer. Additionally, the permissions may control which customers can purchase certain quantities (e.g., retail size, wholesale size, etc.) of products. Further details are included in the accompanying documentation.

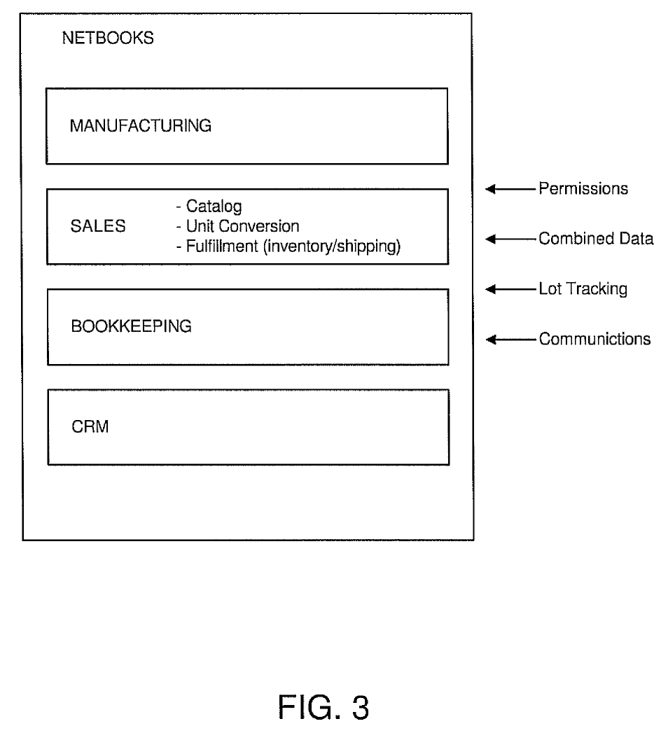

FIG. 3 illustrates a schematic block diagram of another embodiment of the business management system. The depicted business management system (designated as “Netbooks”) includes for functional units: manufacturing, sales, bookkeeping, and customer relations management (CRM). Each of these functional business units represents a subset of business management operations that may be implemented to facilitate management of the corresponding business units. Details of many operations that may be implemented in embodiments of the business management system are described in the accompanying documentation.

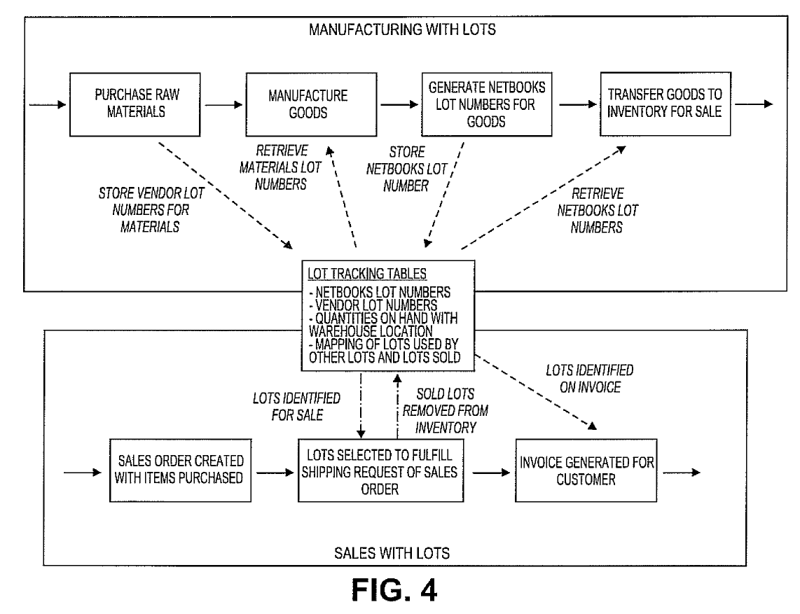

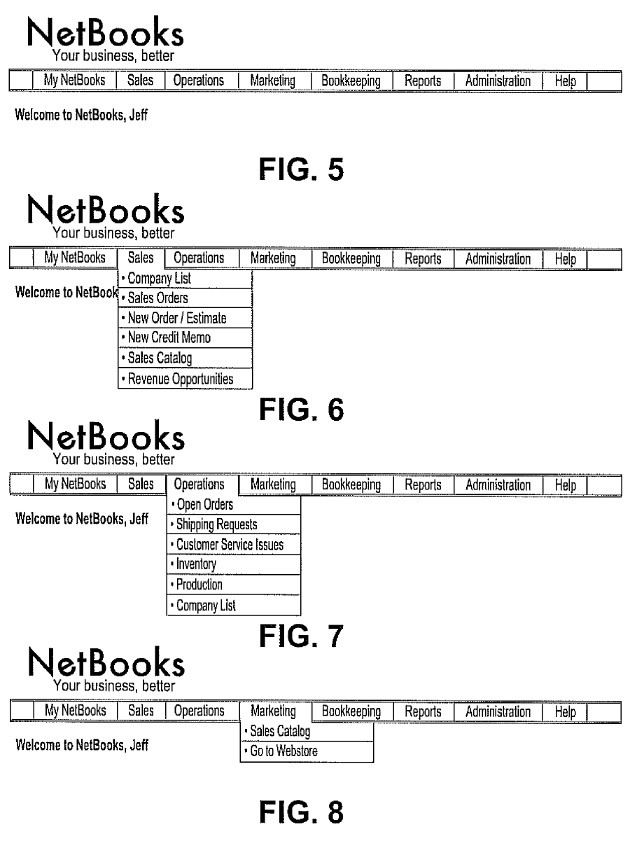

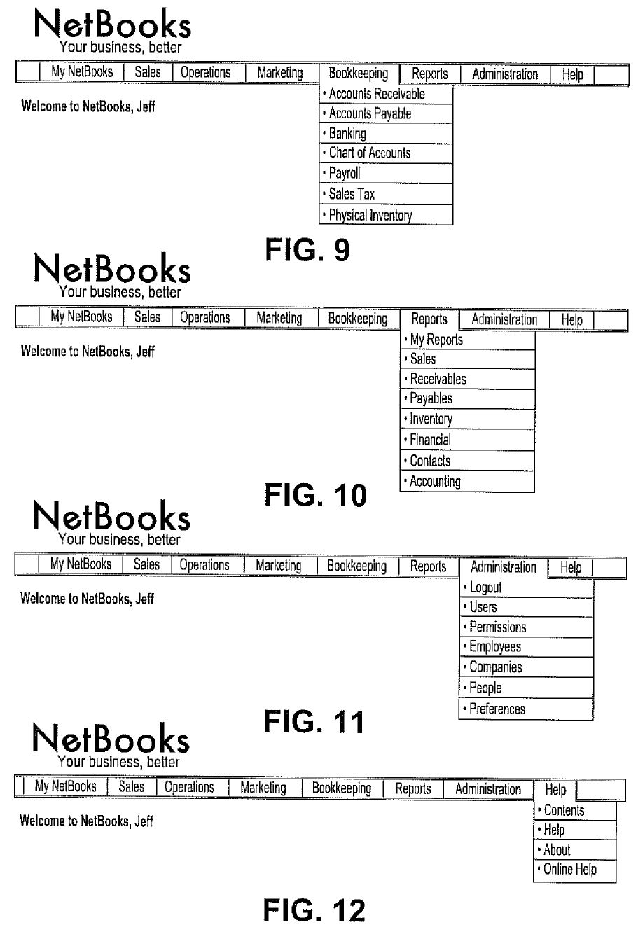

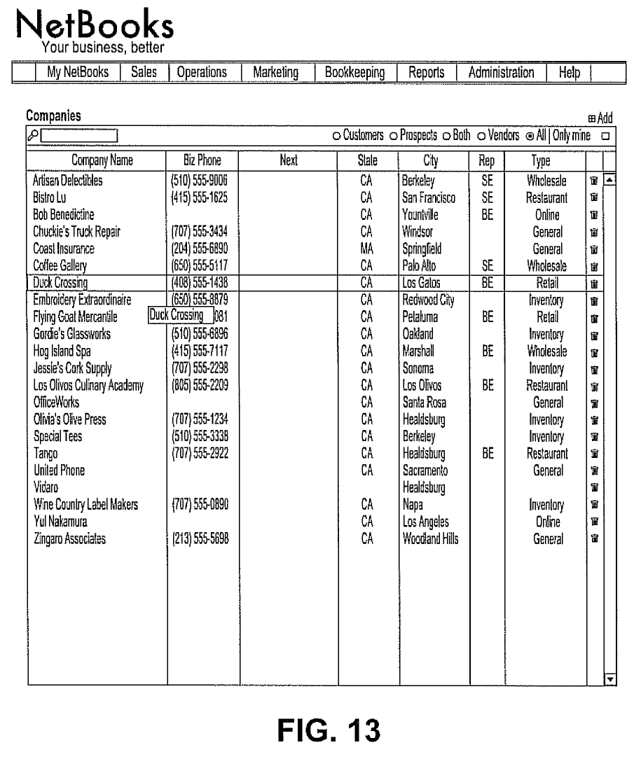

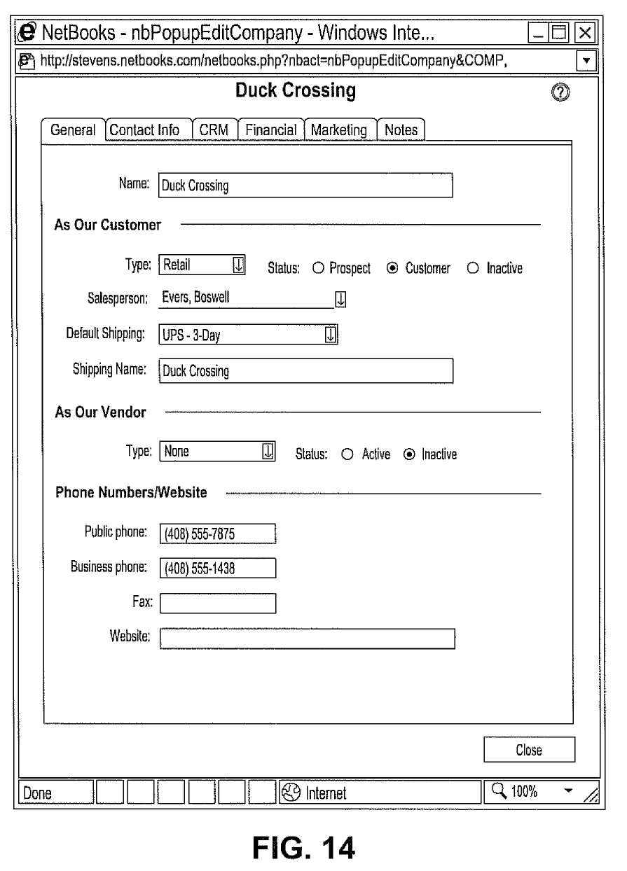

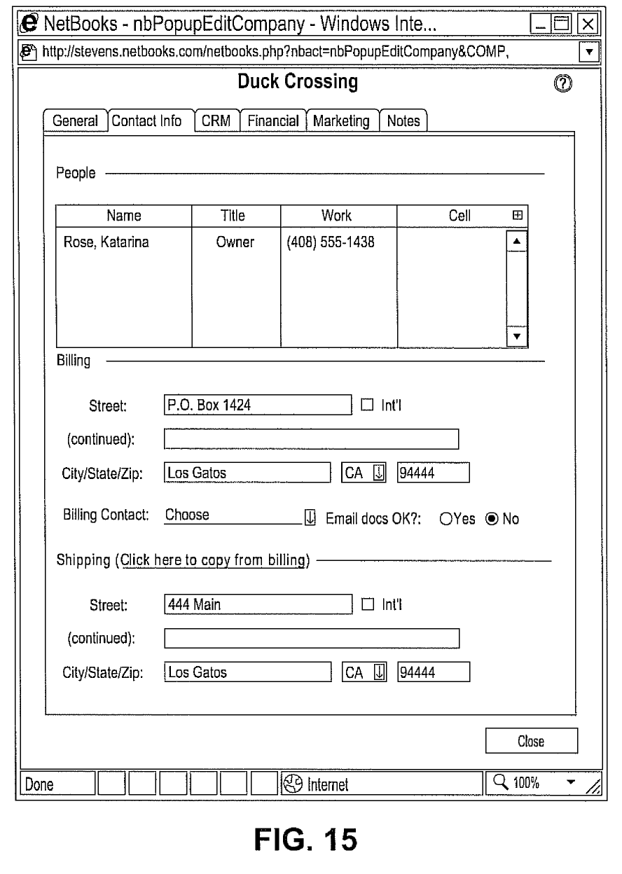

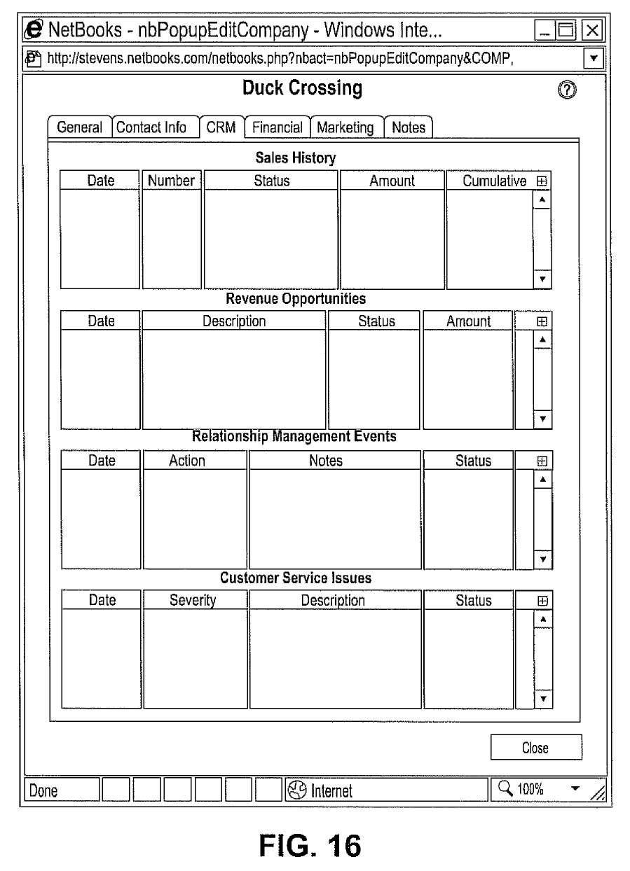

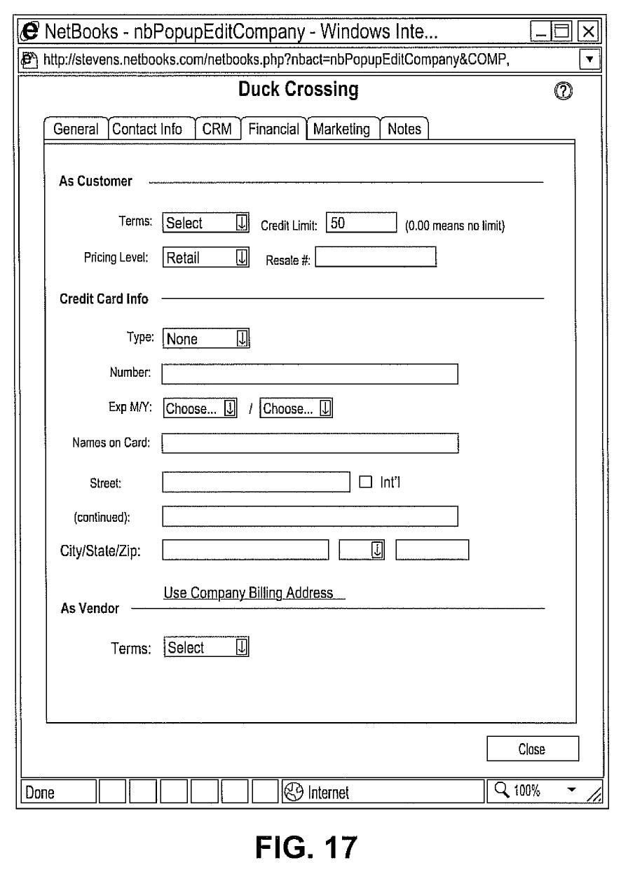

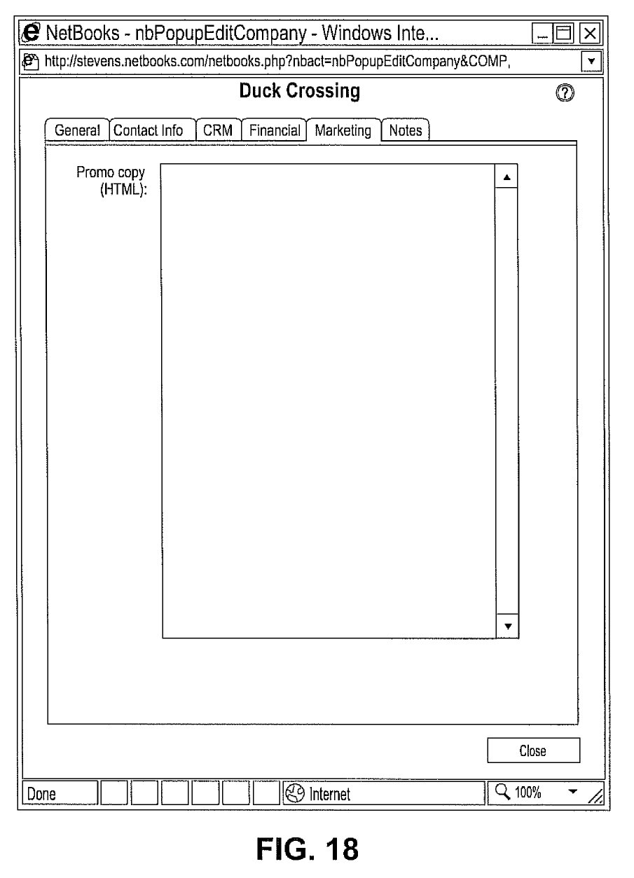

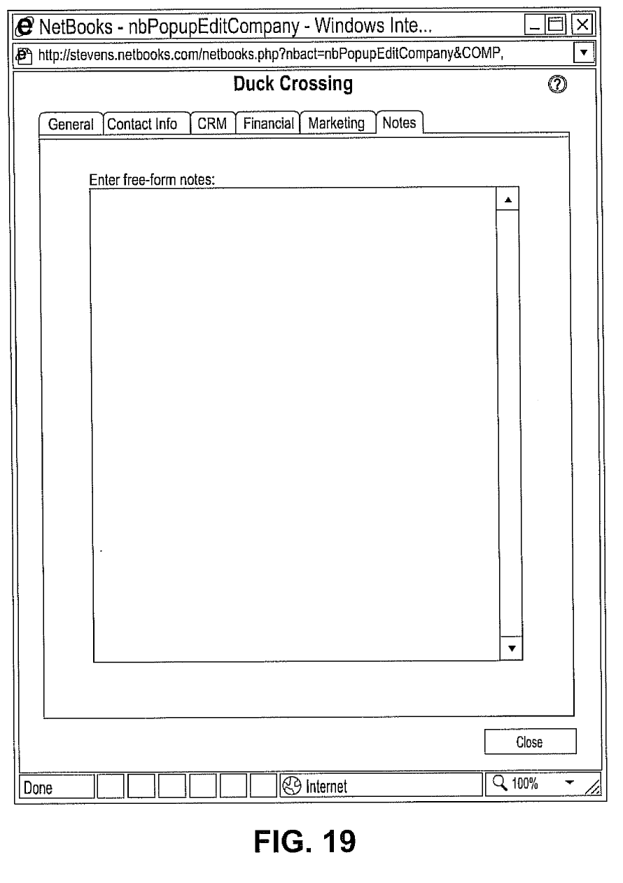

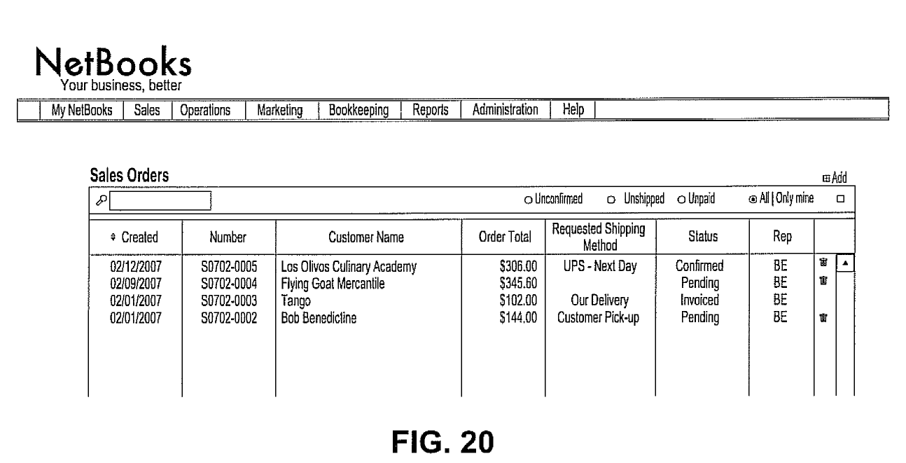

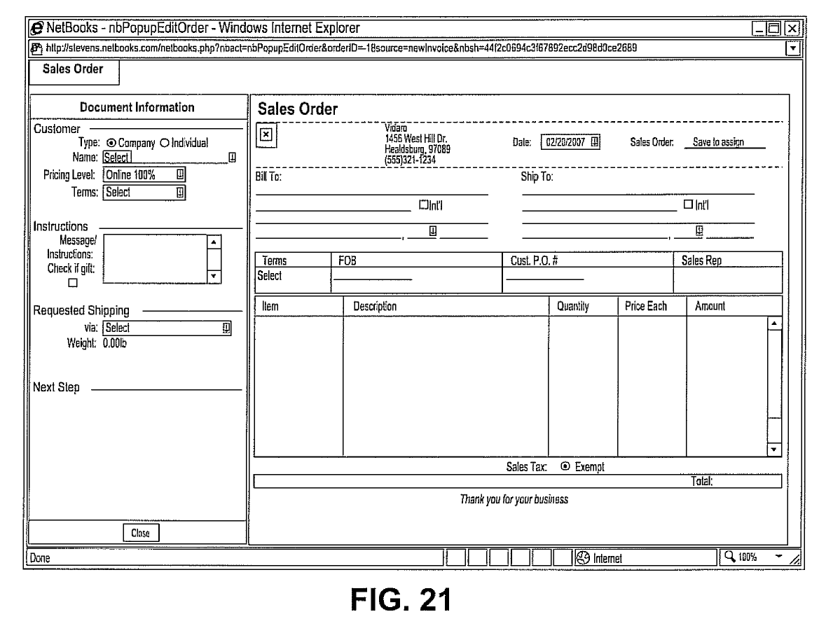

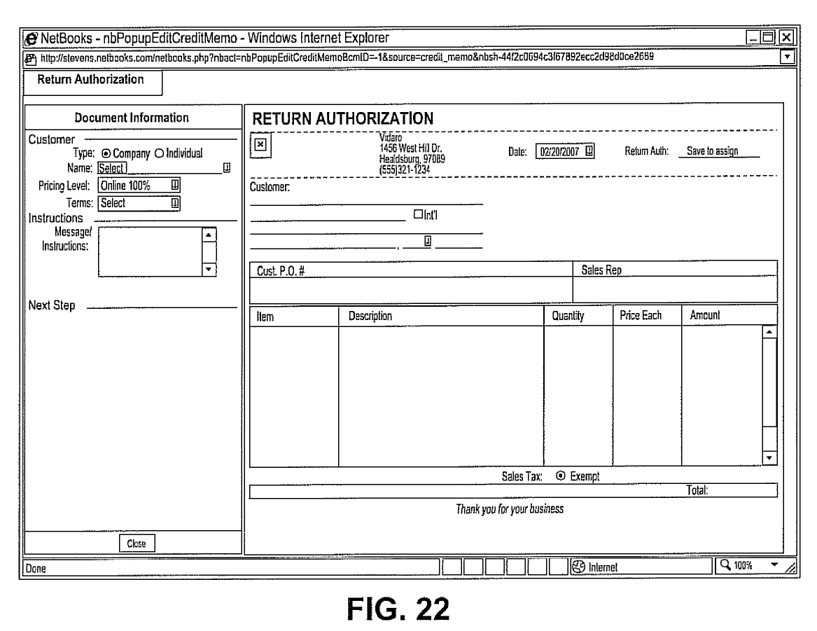

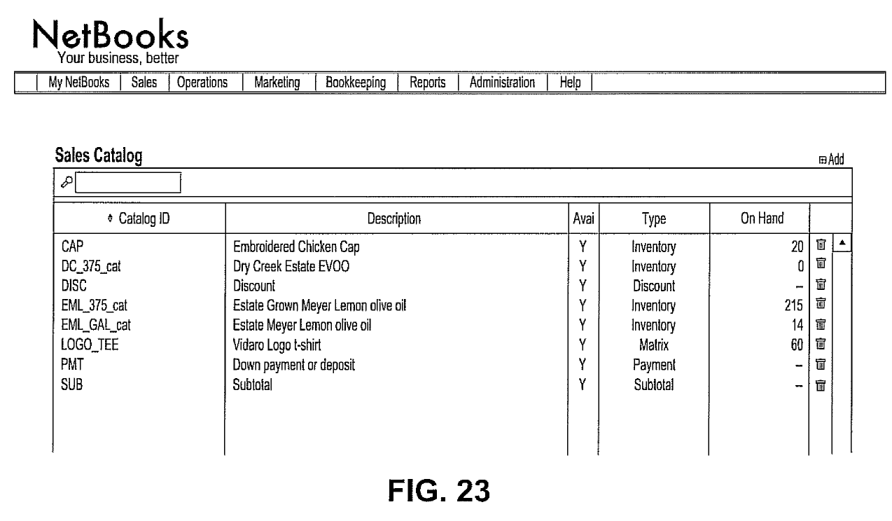

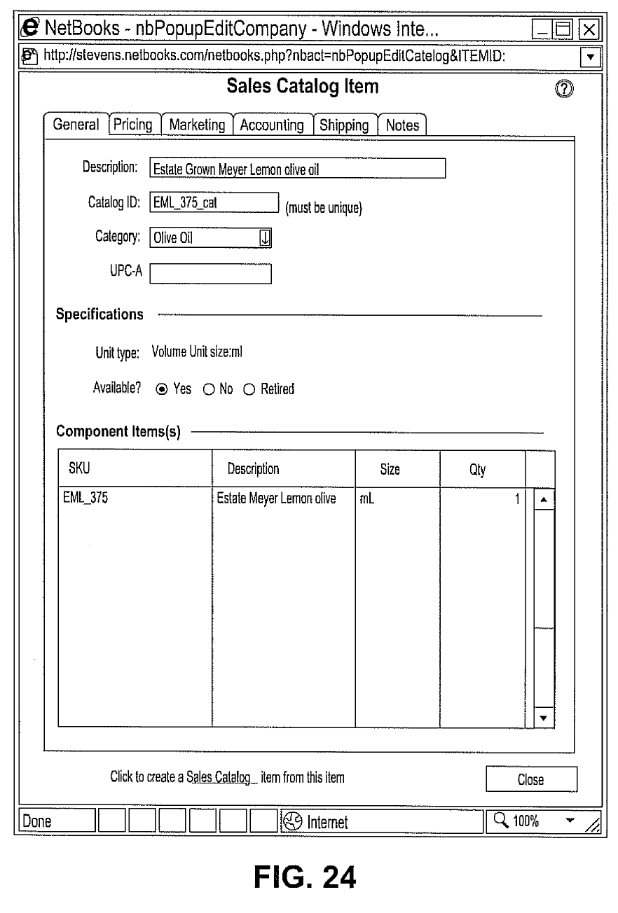

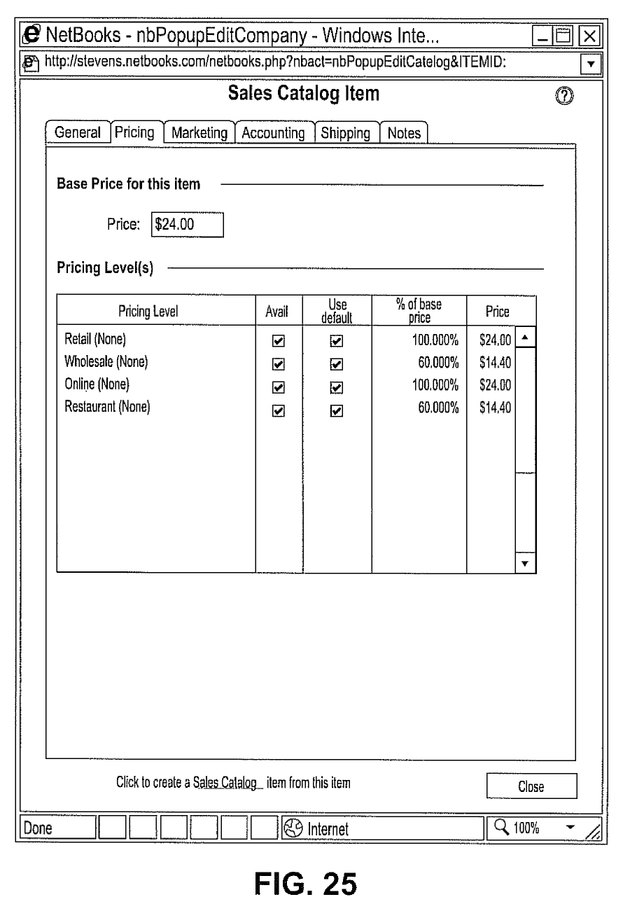

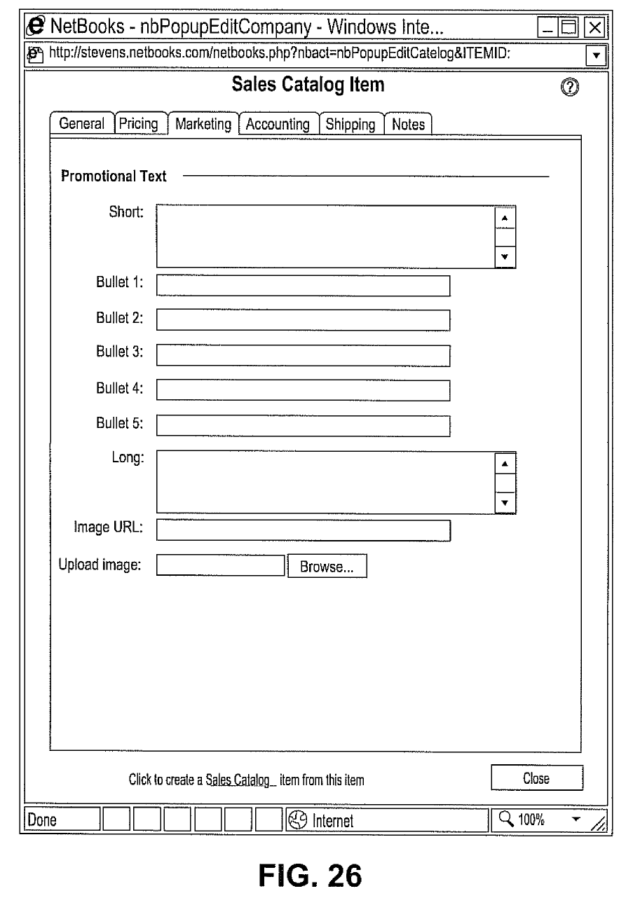

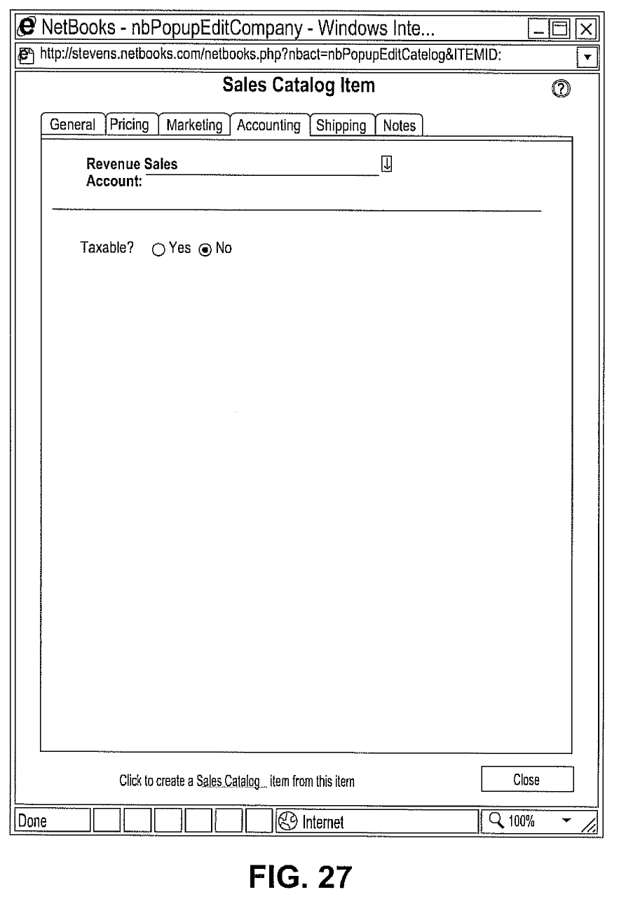

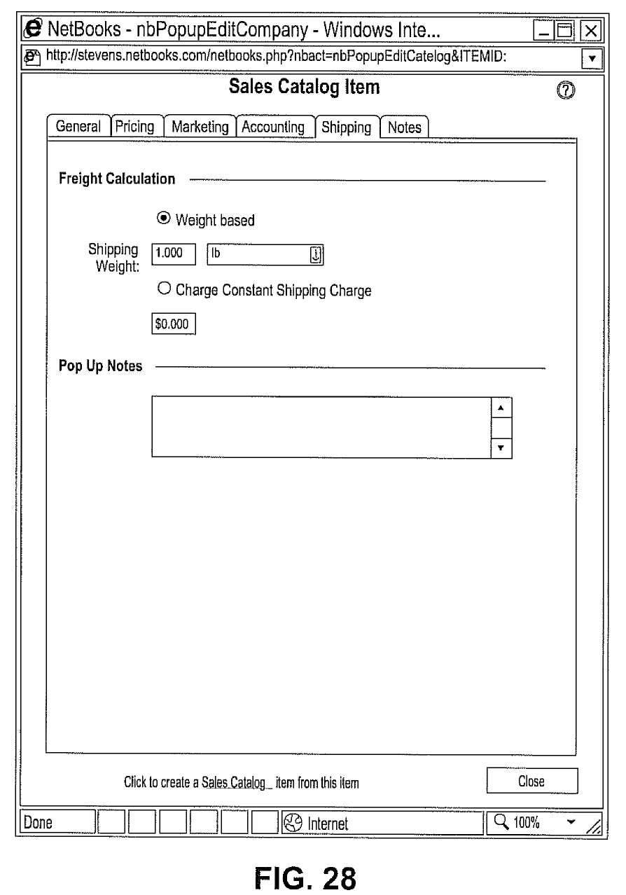

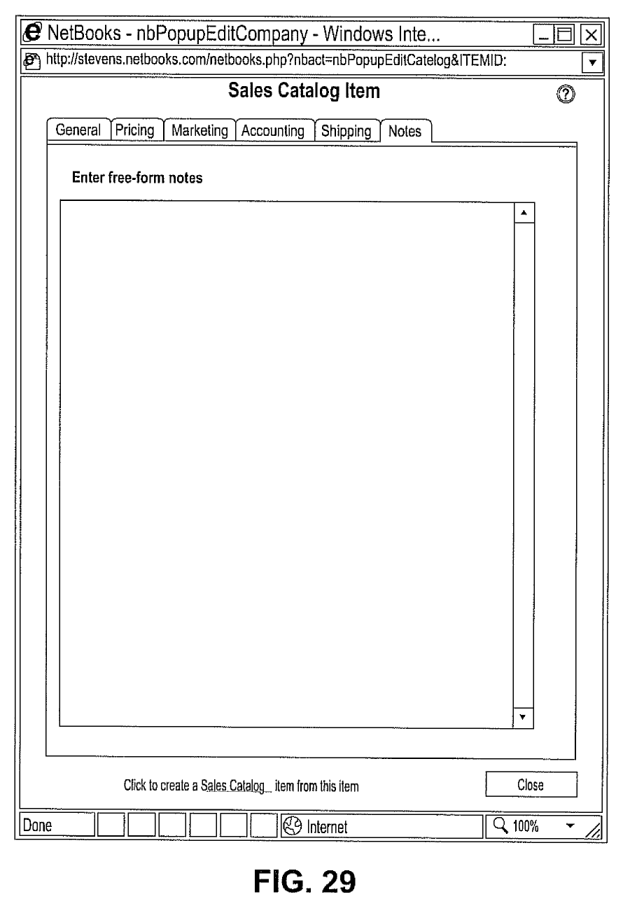

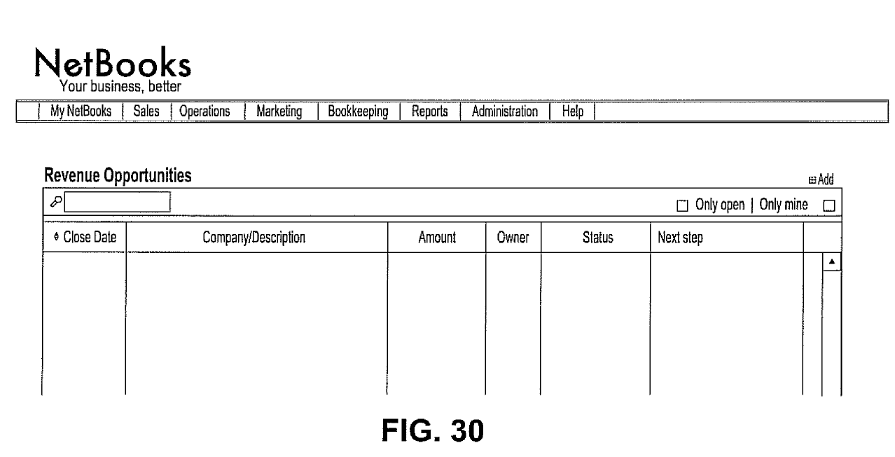

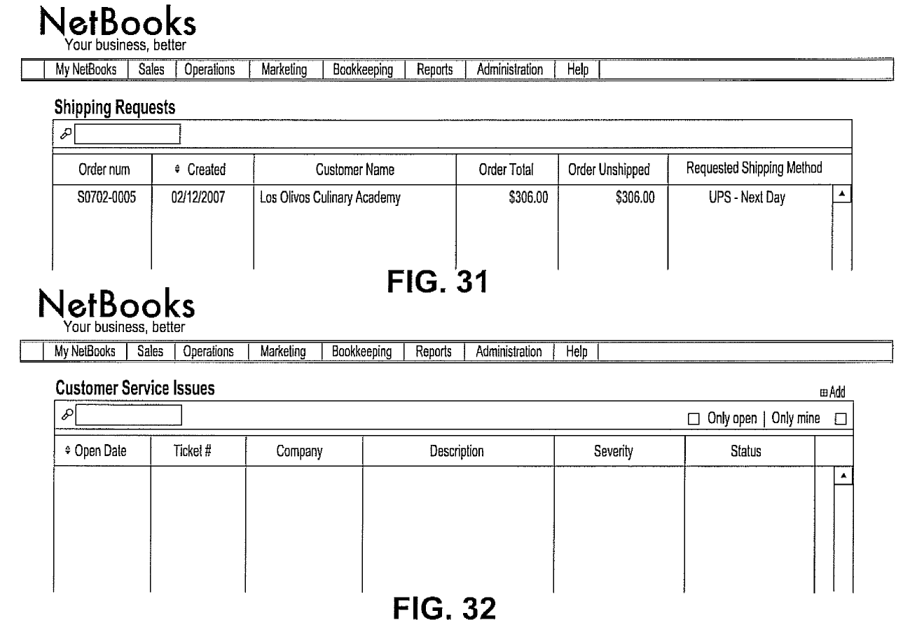

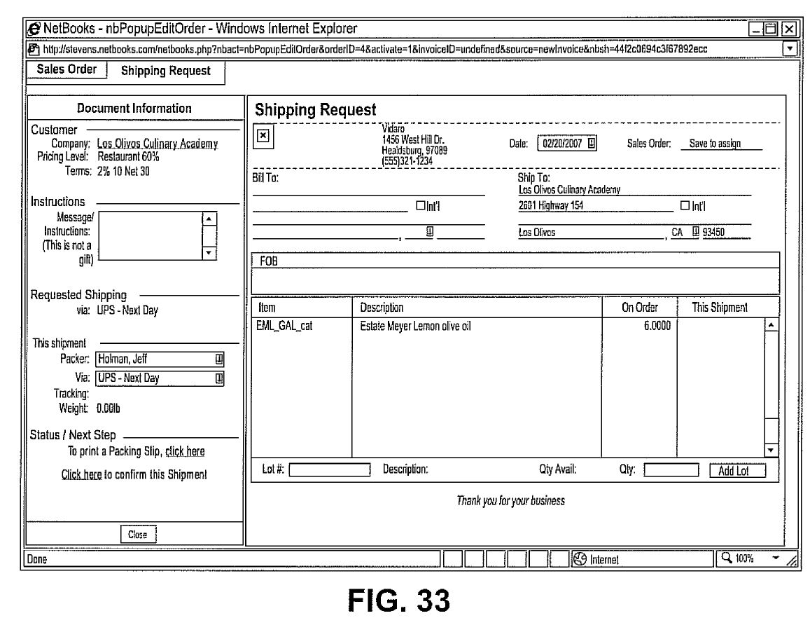

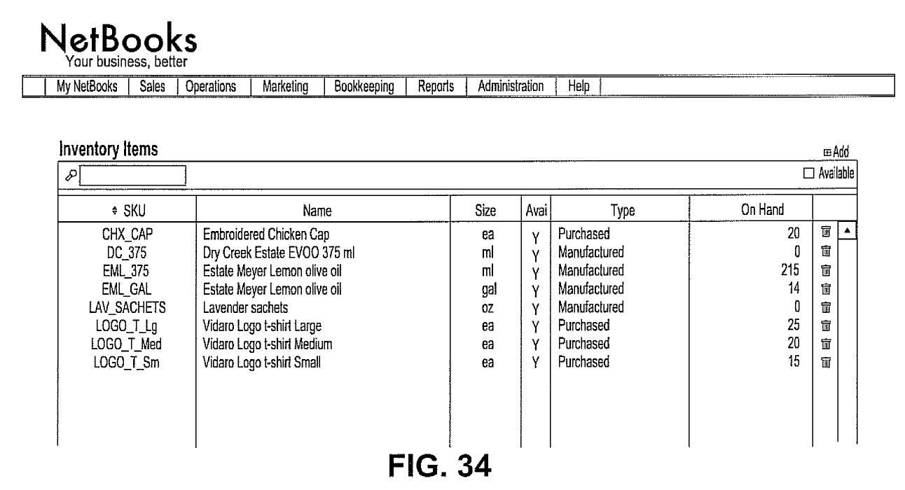

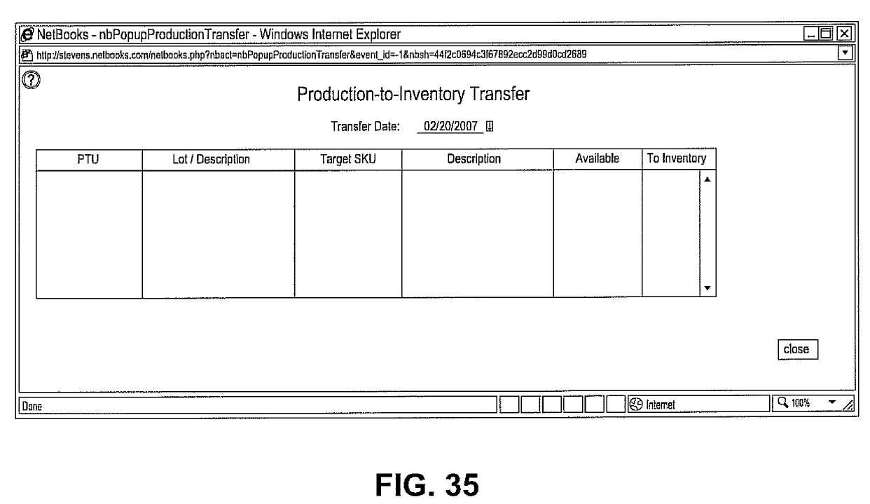

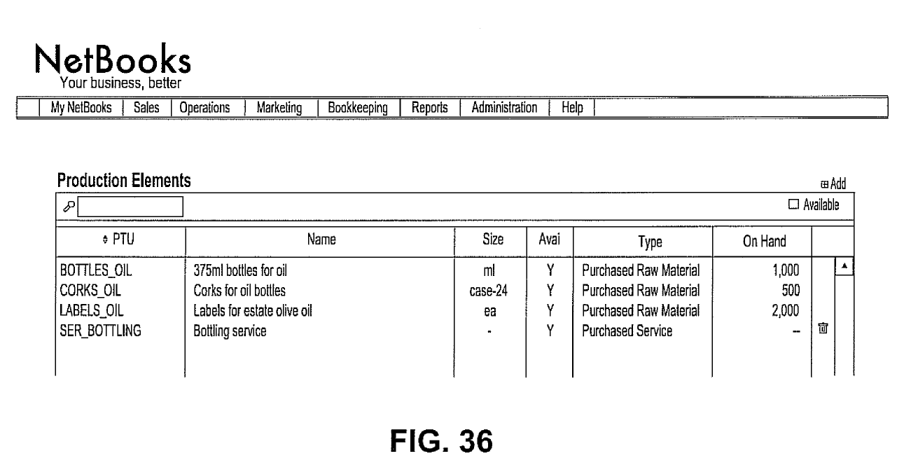

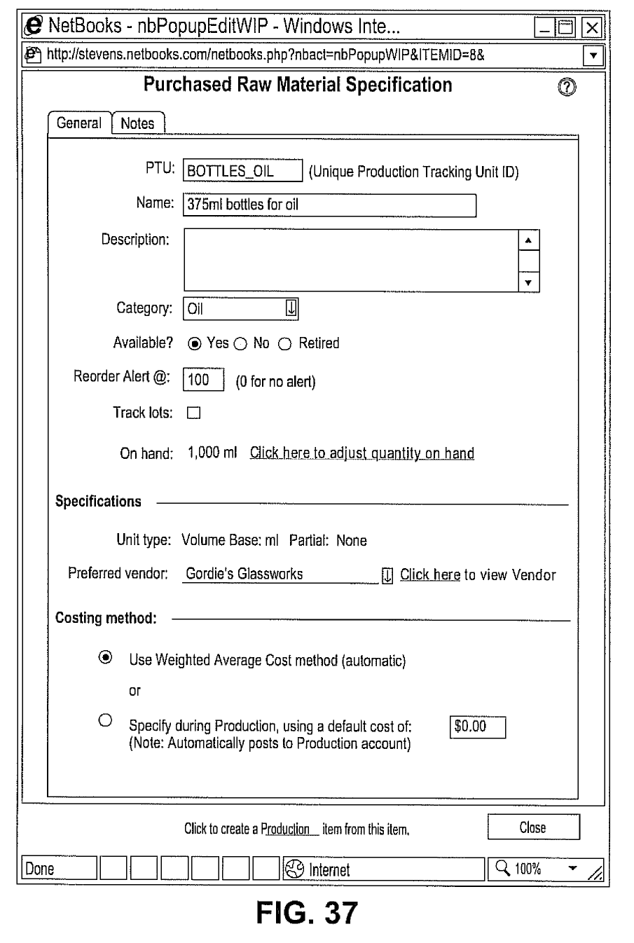

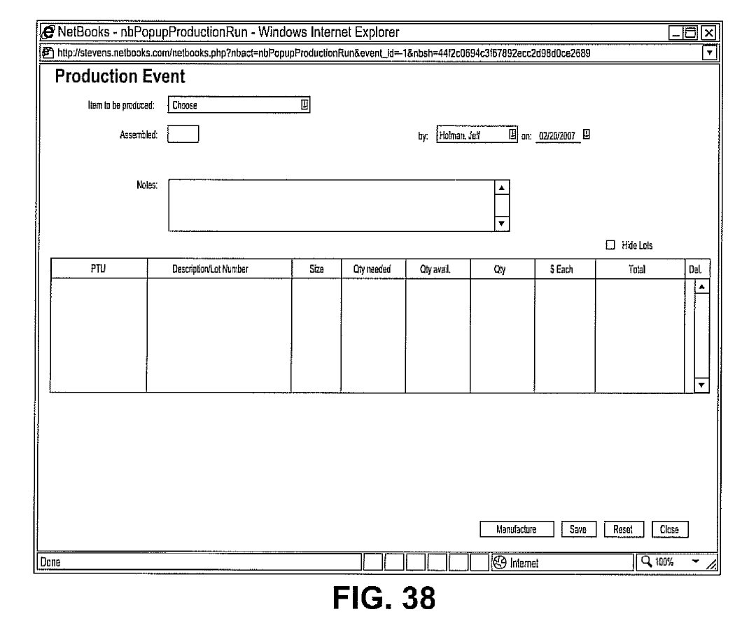

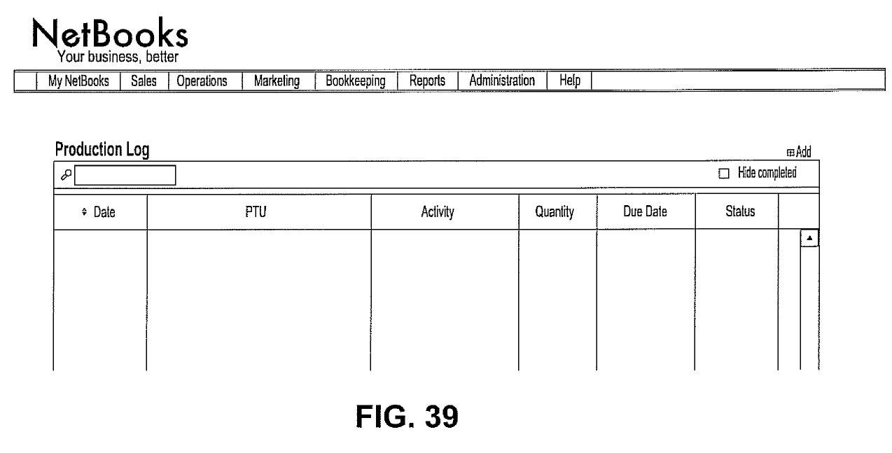

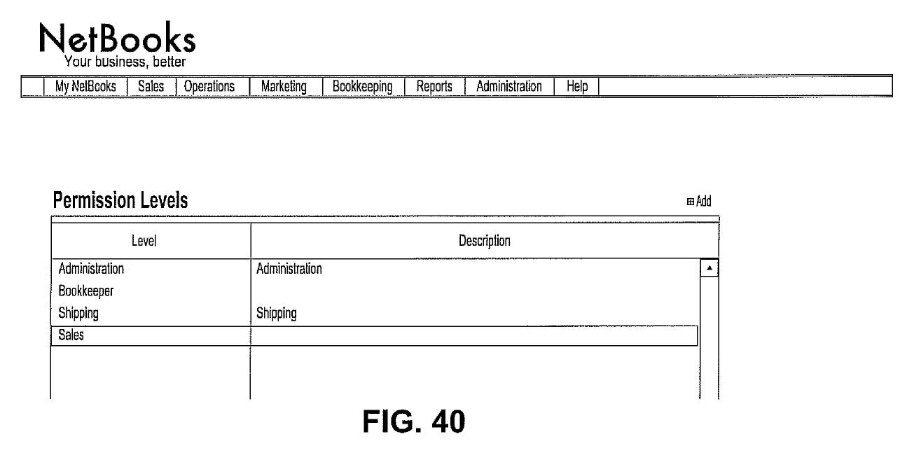

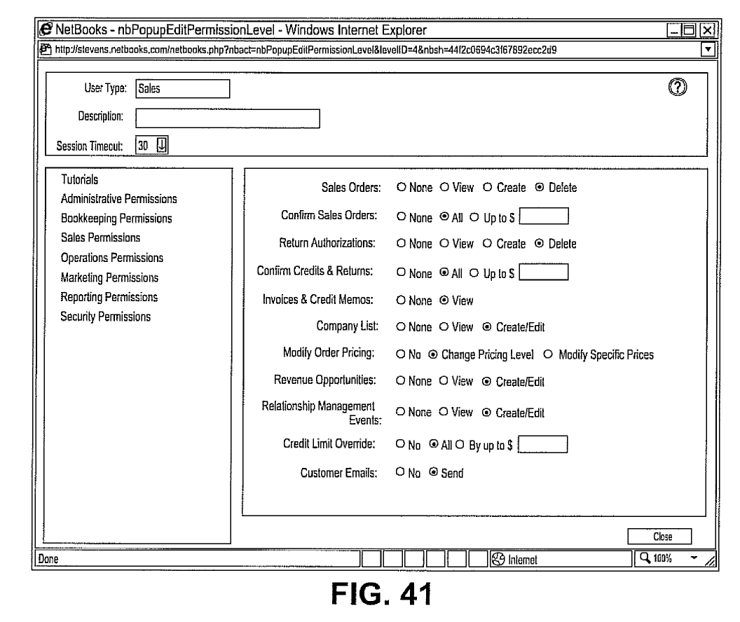

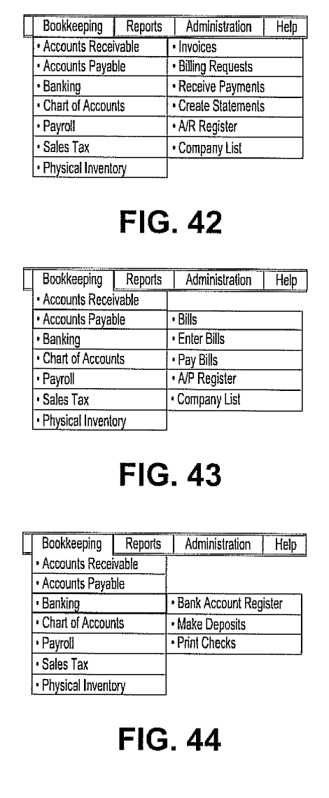

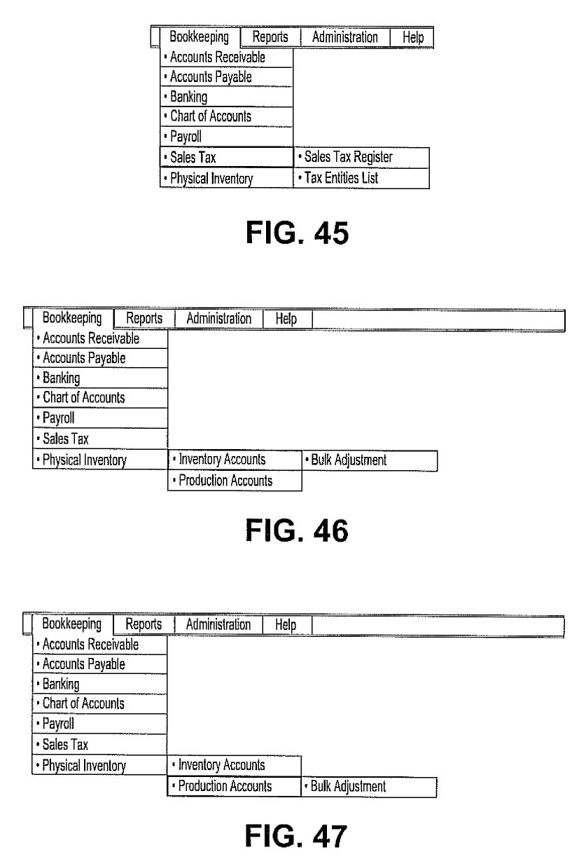

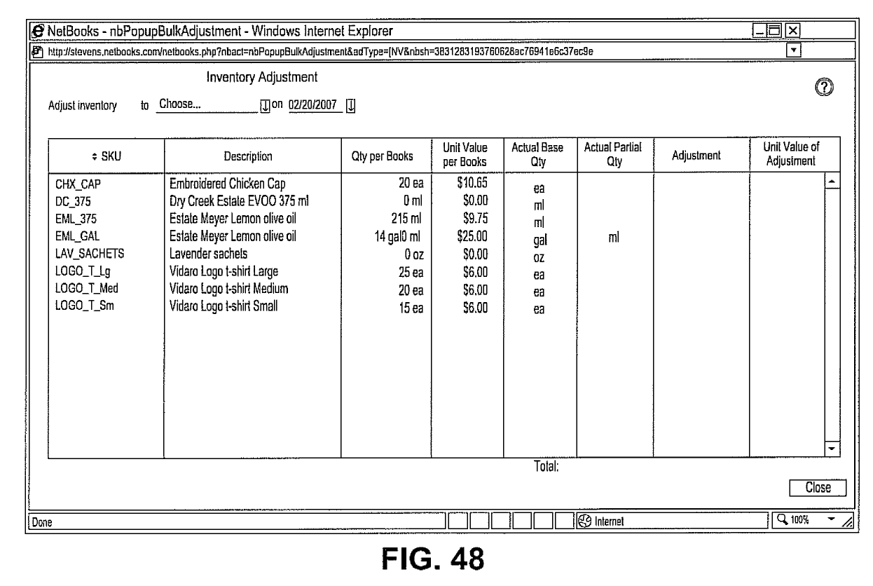

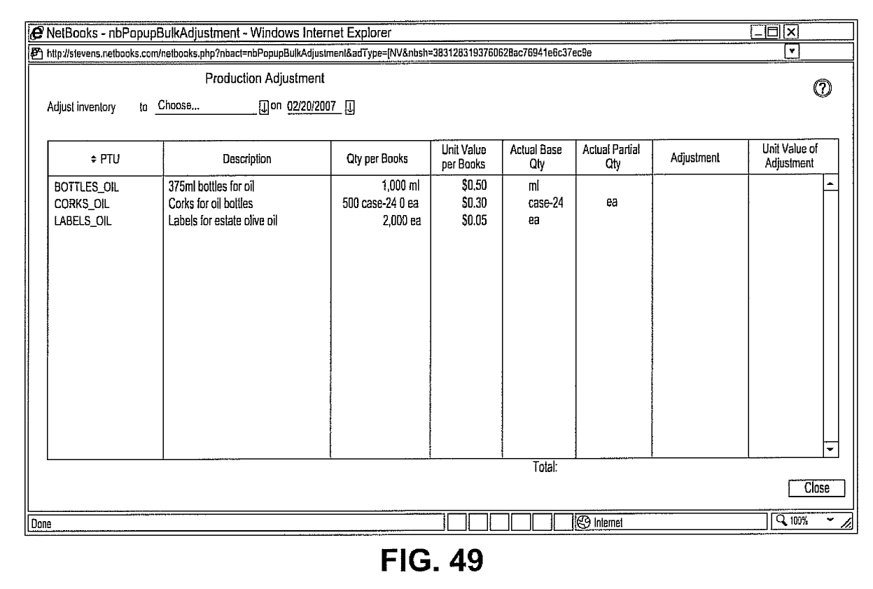

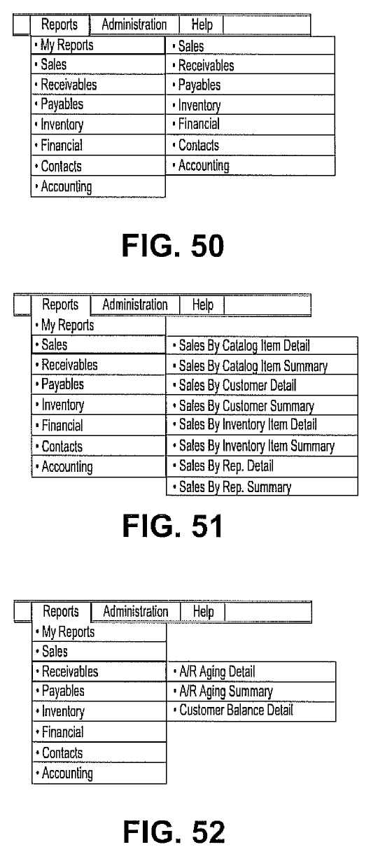

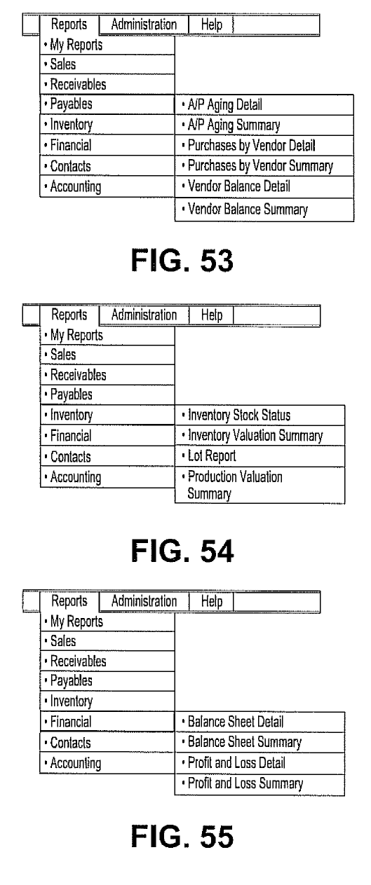

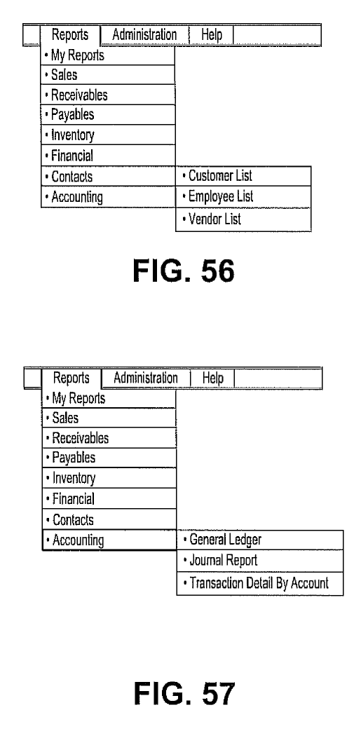

It should be noted that each of these functional business units also may include subsets of additional functionality. As an example, the sales unit may include functionality to implement the catalog, unit conversion, and fulfillment (e.g., inventory and shipping). Additionally, an embodiment of the business management system implements operations that are common across the several functional business units. For example, one embodiment of the business management system implements permissions, data access, lot tracking, and communications. The implementation of these operations and functional units is described in more detail in the accompanying documentation. Additionally, lot tracking is described in more detail with reference to FIG. 4.

FIG. 4 illustrates a process flow diagram of one embodiment of the functionality of lot tracking. In general, lot tracking refers to tracking raw materials, and the products that are generated from those raw materials, so that there is a record to show which customers ultimately receive various portions of the raw materials. In order to facilitate lot tracking, the business management system may automate many operations related to lot tracking. Additionally, the business management system allows a user to assign internal lot numbers to the raw materials, and to coordinate the internal lot numbers with lot numbers from vendors and other external entities. FIG. 4 specifically shows how lot numbers may be tracked during the manufacturing and sales processes. These processes are implemented, at least in part, using computer software and hardware, including the data repository shown in FIG. 1. In one embodiment, one or more lot tracking tables are stored in the data repository.

During manufacturing, the lots are tracked as raw materials are purchased, manufactured, and transferred to inventory. As an example, lot numbers assigned by the vendor to the raw materials are entered into the lot tracking tables when the raw material is purchased. As the raw materials are processed to generate the manufactured goods, the vendor lot numbers may be retrieved and assigned to each unit of the manufactured goods. In the lot tracking tables, internal lot numbers are then associated with the vendor lot numbers. Additionally, the internal lot numbers are associated with the manufactured goods. In this way, the lot tracking tables store data to correlate the vendor lot numbers, the internal lot numbers, and the manufactured goods. The lot tracking tables also may store other information such as inventory quantities on hand, as well as warehouse locations of the various units in inventory. The lot tracking tables also may store additional internal lot numbers used in sub-stages of the manufacturing process, so that raw materials used in each stage of the manufacturing process may be tracked and correlated back to the vendor lot number. After the internal lot numbers have been assigned to the manufactured goods, the manufactured goods may be transferred to inventory. While the lot numbers also may be separately transferred to inventory, one embodiment of the business management system allows the inventory personnel to access the same lot tracking tables, so that the manufacturing and inventory personnel use the same instance of the lot tracking numbers. The use of a single instance of data can help to avoid confusion and errors that might occur if the data were copied or otherwise not available to both functional business units.

During sales, generally, the business management system tracks which lots are distributed to which customers. More specifically, when a sales order is created for items purchased, the business management unit tracks and records which lots are selected to fulfill the shipping request corresponding to the sales order. The selected lot numbers are then removed from inventory to indicate that the corresponding items have been shipped (or are reserved to be shipped). In one embodiment, the selected lot numbers are also identified on the invoice that is generated and sent to the customer. In this way, the business management system facilitates lot tracking from the time the raw materials are received from the vendors until the manufactured goods are shipped to the customers.

What is claimed is:

1. A system for providing straight-through processing and integration of disparate business process information, comprising:
an order intake configured to receive an order from a customer;
a fulfillment processor configured to automatically fulfill an order received;
an inventory tracker configured to automatically account for the fulfilled order upon fulfillment; and
an accounting processor configured to automatically invoice a customer for the fulfilled order.

2. A system according to claim 1, wherein the order intake is configured to receive and automatically straight-through process order requests from an existing customer upon identification of the customer upon receiving a request to place an order.

3. A system according to claim 1, further comprising a permissions tracker configured to approve an order when predetermined customer conditions are met, wherein the fulfillment processor is configured to receive and automatically straight-through process orders from an existing customer upon identification of the customer upon placing an order when the conditions are met.

4. A system according to claim 3, wherein the permission tracker is configured to approve an order when the condition of an account being current is met, wherein the fulfillment processor is configured to receive and automatically process orders from an existing customer upon identification of the customer upon placing an order when the account is current.

5. A system according to claim 1, further comprising a permissions tracker configured to approve an order when an account is current, wherein the fulfillment processor is configured to receive and automatically process orders from an existing customer upon identification of the customer upon placing an order when the order is approved.

6. A system according to claim 1, further comprising:
a universal business user access interface configured to receive orders directly from customers and also from approved sales agents authorized to receive and place orders; and
a permission tracker configured to approve an order from customers and from approved agents when predetermined customer conditions are met, wherein the fulfillment processor is configured to receive and automatically straight-through process orders from an existing customer upon identification of the customer upon placing an order when the predetermined customer conditions are met, and further configured to block orders when the predetermined customer conditions are not met.

7. A system according to claim 6, further comprising a permission override configured to allow an order to be processed when overridden by an authorized user.

8. A system according to claim 6, wherein the conditions are a confirmation of a current customer account, wherein the system is configured to first receive an order, determine whether a customer's account is current, approve the order if the account is current, and block the order when the account is not current.

9. A system according to claim 1, further comprising an alert system configured to alert predetermined business users when an order request is received.

10. A system according to claim 1, further comprising a batch processor configured to track the costs of producing a product as it is manufactured.

11. A system according to claim 1, further comprising a batch processor configured to track the costs of producing a product as it is manufactured, including product subassembly costs and related product service costs.

12. A system according to claim 1, further comprising a batch processor configured to track the costs of services for producing a product as it is manufactured.

13. A system according to claim 1, wherein the inventory tracker further includes a lot tracker configured to track the inventory of products categorize as a particular lot.

14. A system according to claim 13, wherein the inventory tracker further includes a lot reporter configured to generate a lot report for the inventory of products categorized as the particular lot.

15. A system according to claim 1, wherein the inventory tracker further includes a lot tracker configured to track the inventory of products categorized as a particular lot by first requiring that a lot be identified by a lot identification when an order is placed.

16. A system according to claim 1, wherein the inventory tracker further includes a lot tracker configured to track the inventory of products categorized as a particular lot by first requiring that a lot be identified by a lot identification when an order is placed, and requiring that the existence of the identified lot be verified before the order is fulfilled.

17. A system according to claim 1, further comprising a communication logger configured to maintain a centralized repository of electronic communications from different business units for the order from the customer.

18. A system according to claim 3, wherein the predetermined customer conditions comprise a customer type, wherein the customer type comprises a retailer, a distributor, and a wholesaler.

19. A system according to claim 1, further comprising a retail point-of-sale processor configured to provide a retail point of sale interface for a customer to sell product to a patron of the customer.
